(19) United States
(12) Patent Application Publication
(10) Pub. No.: US 2023/0264481 A1
(43) Pub. Date: Aug. 24, 2023

(54) ANALYSING IMAGE DATA TO COMPENSATE FOR A PRINTING ARTEFACT

(71) Applicant: Hewlett-Packard Development Company, L.P., Spring, TX (US)

(72) Inventors: Eduardo AMELA CONESA, Sant Cugat del Valles (ES); Marta BLANCH PINOL, Sant Cugat del Valles (ES); Diana CANTO ESTANY, Sant Cugat del Valles (ES)

(73) Assignee: Hewlett-Packard Development Company, L.P., Spring, TX (US)

(21) Appl. No.: 18/004,062

(22) PCT Filed: Jul. 2, 2020
(86) PCT No.: PCT/US2020/040601

§ 371 Date: Jan. 2, 2023

(51) Int. Cl. B41J 2/21; G06K 15/02; G06T 7/00; G06T 7/13

(52) U.S. Cl. CPC B41J 2/2132; G06K 15/027; G06T 7/0004; G06T 7/13; G06K 2215/101; G06T 2207/30144

(57) ABSTRACT

The disclosure relates to the analysis of digital contone image data (302) to compensate for a printing artefact, by identifying overlapping segments (202, 204) where print agent is to be printed in adjacent bands of the image, and defining a compensation for the artefact in an edge region (208) of a segment (204) based on an evaluation of an artefact criterion. Adjusted digital contone image data (316) is defined based on the compensation.

### BACKGROUND

Inkjet printing systems print an image on a substrate by ejecting a print agent or a plurality of print agents. An inkjet printing operation to print an image may be defined based on image data relating to the image. In an inkjet printing operation, nozzles of a printhead are caused to fire as the printhead scans over the substrate, to eject print agent and thereby print the image.

### BRIEF DESCRIPTION OF DRAWINGS

Examples will now be described, by way of non-limiting example, with reference to the accompanying drawings, in which:

FIG. 1 is a simplified schematic of a substrate printed upon by a printhead of an inkjet printing apparatus to print an image comprising a printing artefact; and

FIG. 2 is a simplified schematic of image analysis elements relating to an image to be printed;

FIG. 3 is a flow diagram of a method of analysing image data to compensate for a printing artefact;

FIGS. 4-7 are simplified schematics of image analysis elements relating to an image to be printed;

FIG. 8 is a flow diagram of a method of analysing image data to compensate for a printing artefact;

FIGS. 9 and 10 are simplified schematics of image analysis elements;

FIG. 11 is a simplified schematic of an inkjet printing apparatus; and

FIG. 12 is a simplified schematic of a machine readable medium comprising instructions, and a processor.

### DETAILED DESCRIPTION

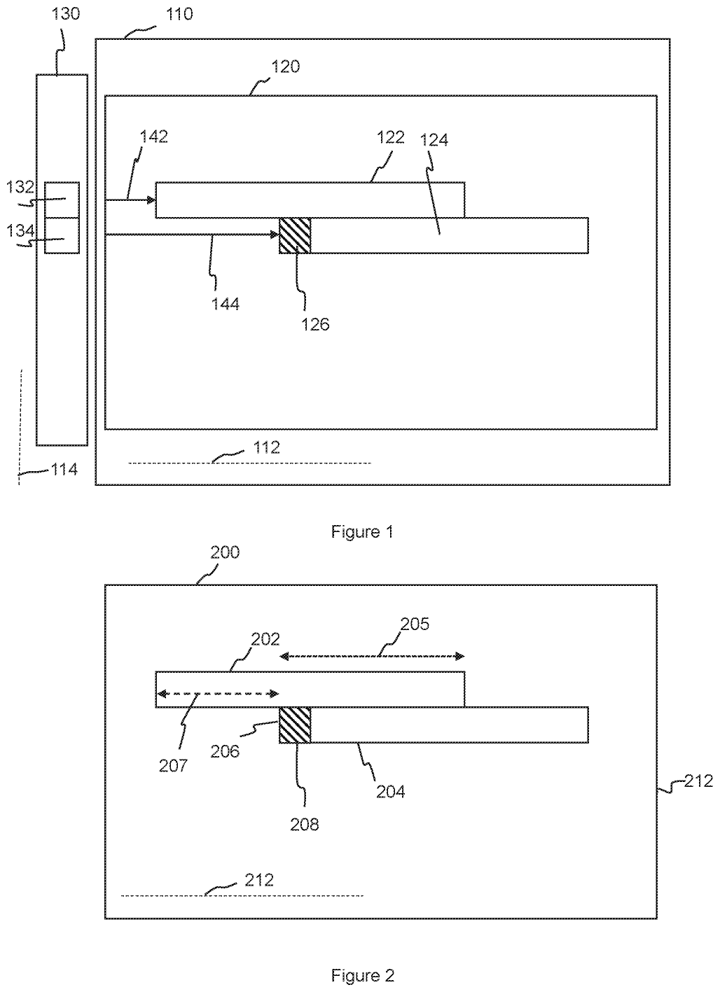

FIG. 1 shows an example printed image 120 printed on a substrate 110 by an inkjet printing apparatus comprising a printhead 130, based on digital contone image data. The digital contone image data may define an image by specifying contone levels at print-addressable locations within the image, for one colour channel or for more than one colour channel (such as CMYK channels).

The following description illustrates a printing artefact that may occur in inkjet printing with reference to the printed image 120, and is based on a simplified example image for this purpose. It will be appreciated that the disclosure is equally applicable to printed regions having any shape and form. The following description refers to elements of the printed image 120, which reflects the underlying image defined by the image data except for the printing artefact.

The example printed image 120 comprises one region of uniform tone and colour having the shape of two overlapping elongate rectangular portions 122, 124. The printed image 120 has an orientation with respect to a scanning axis 112 of a printhead 130 whereby the two portions 122, 124 are each elongate along the scanning axis 112 with uniform depth along a feed axis 114 perpendicular to the scanning axis 112. The rectangular portions 122, 124 are adjacent one another along the feed axis. The two portions 122, 124 are each elongate along the scanning axis 112 between opposing edges, with elongate sides extending between the edges along the scanning axis 112. The two portions 122, 124 are adjacent to each other with respect to the feed axis 114, such that two respective sides of the portions are contiguous where the two portions 122, 124 overlap along the scanning axis. With reference to the orientation of the printed image as shown in FIG. 1, an upper one of the portions 122 extends along the scanning axis towards a left side of the image beyond an adjoining edge of the other portion 124.

An example printhead 130 of an inkjet printing apparatus for printing on the substrate comprises a plurality of nozzles selectively controllable to eject a print agent (or a plurality of print agents), and is to scan over the substrate 110 along the scanning axis 112 to print the image 120. FIG. 1 shows two sets of nozzles 132, 134 from a plurality of nozzles arranged along the printhead, and which are respectively aligned with the position of the two portions of the image 122, 124 with respect to the feed axis.

In a pass of an inkjet printing operation, both sets of nozzles 132, 134 may be fired as the printhead 130 passes over the substrate 110 along the scanning axis. As illustrated in FIG. 1, in a left-to-right printing pass, the printhead 130 may move a first distance 142 from the left lateral side of the image before printing commences with the first set of nozzles 132 corresponding to the upper portion 122, whereas the printhead 130 may move a longer second distance 144 from the left lateral side of the image before printing commences with the second set of nozzles 134 corresponding to the lower of the portions 124. At the time that printing commences with the second set of nozzles 134, the second set of nozzles 134 will have been inactive for an idle time corresponding to the printhead traversing a distance which is at least the second distance 144, whereas the first set of nozzles 132 will have been active and continue printing. Accordingly, at that time, print agent ejection behaviour may be different between the first set of nozzles 132 and the second set of nozzles 134, which may lead to a visible printing artefact in an edge region 126 of the lower portion 124 adjacent the adjoining edge (i.e. the edge of the lower portion 124 that is adjacent to the upper portion 122 which projects beyond it towards the respective (left) lateral side of the printed image 120).

For example, a print agent artefact referred to in the art as “decel” may occur in the edge region 126. Decel relates to relatively slower ejection of print agent from a nozzle than is expected under normal conditions. Without wishing to be bound by theory, it is thought that relatively slower rate may be due to factors such as a film of print agent over the nozzle accumulating or becoming more viscous (owing to drying), or print agent within the nozzle becoming more viscous. Decel is thought to result in a relatively darker tone being formed in the affected area of a printed image. Another example print agent artefact which may occur owing to inactivity of a nozzle is referred to in the art as decap. Decap relates to print agent drying within a nozzle, one effect of which is a reduced volume of ejected print agent, which may result in relatively lighter tone being formed in the affected area of a printed image. Another example print agent artefact is dye enrichment, whereby changes may occur in print agent within a nozzle during a period of activity which result in a relatively higher concentration of dye and solvent, resulting in the print agent having a darker tone when printing resumes. Such changes may include dye settling and solute evaporation.

Such artefacts may occur within an edge region of a printed region corresponding to commencement of printing with the respective nozzles, and the intensity of the artefact (i.e. the degree to which it diverges from expected behaviour) may be graduated from the respective edge, for example as the nozzles warm up.

Such artefacts may be particularly visually noticeable when an affected edge region is adjacent to an unaffected printed region that, according to the image data, is to have the same or similar tone. For example, in the image 120 of FIG. 1, the edge region 126 of the lower portion 124 is affected by an artefact (which may be graduated along the scanning axis within the edge region 126), and is adjacent to a part of the upper portion 122 which is offset from the respective edge of the upper portion 122 such that it is unlikely to be affected by the same artefact. Accordingly, the artefact in the edge region 126 may be particularly visually noticeable owing to the contrast between the adjacent regions. Conversely, an artefact within an edge region which is not adjacent to such an unaffected printed region may be less visually discernible.

The examples disclosed herein relate to the analysis of image data to compensate for such printing artefacts.

FIG. 2 schematically shows a representation of image elements corresponding to an image defined by digital contone image data. The image elements illustrate features of an image which may be used in an analysis of image data as described herein. The image elements may visually correspond to features of the image itself and are shown in a corresponding two dimensional image space, but it is to be recognised that the image elements are derivable from the image data, and may not be directly reflected in the structure of the image data itself, or in objects of a computer-implemented analysis. For example, digital contone image data may be defined in the form of a bitmapped image. Image elements such as discrete print agent regions, as described below, may be derivable from image data by an analysis method, but it may be that such image elements are not explicitly defined within the image data itself.

In the example of FIG. 2, the image elements comprise an image space 200 corresponding to a boundary of the image, and two elongate print agent segments 202, 204 (which in this example correspond in form to the rectangular portions 122, 124 of FIG. 1). As will be described below, to analyse digital image data defining an image, an orientation of the image is determined relative to a scanning axis 212 corresponding to scanning of a printhead to print the image. This may permit the image data to be analysed with respect to bands of the image that extend along the scanning axis 212. The print agent segments 202, 204 lie within bands of the image such that they are each elongate along the scanning axis between opposing edges. The print agent segments correspond to locations within the respective bands where print agent is to be applied, as may be derived based on the image data. While in this simplified example selected boundaries of a region of the image where print agent is to be applied (a “print agent region”) conveniently aligns with the scanning axis 212, the disclosure is equally applicable to images in which the boundaries of print agent regions are not aligned with a scanning axis 212 or any other aspect of an analysis framework for an image, and may take any form however complex.

In this example, the print agent segments 202, 204 lie within adjacent bands of the image, and overlap so that one of them (in this example, the upper print agent segment 202 in the orientation of FIG. 2) projects along the scanning axis 212 beyond an adjoining edge 206 of the other (in this example, the lower print agent segment 204 in the orientation of FIG. 2) by an offset 207.

The image elements further comprise an edge region 208 of the print agent segment having the adjoining edge 206 (i.e. the lower print agent segment 204, in this example).

The example image elements correspond to an example analysis of image data to compensate for a printing artefact relating to printing with a print agent. As described above with respect to FIG. 1 in the context of an example printed image having the same form as the image elements of FIG. 2, in a printed image, a printing agent artefact may occur in an edge region of a printed portion of the image as respective nozzles in a printhead commence printing following a period of inactivity. When analysing the image data, a compensation for such an artefact may be defined in the edge region 208 based on evaluating an artefact criterion at the respective adjoining edge 206.

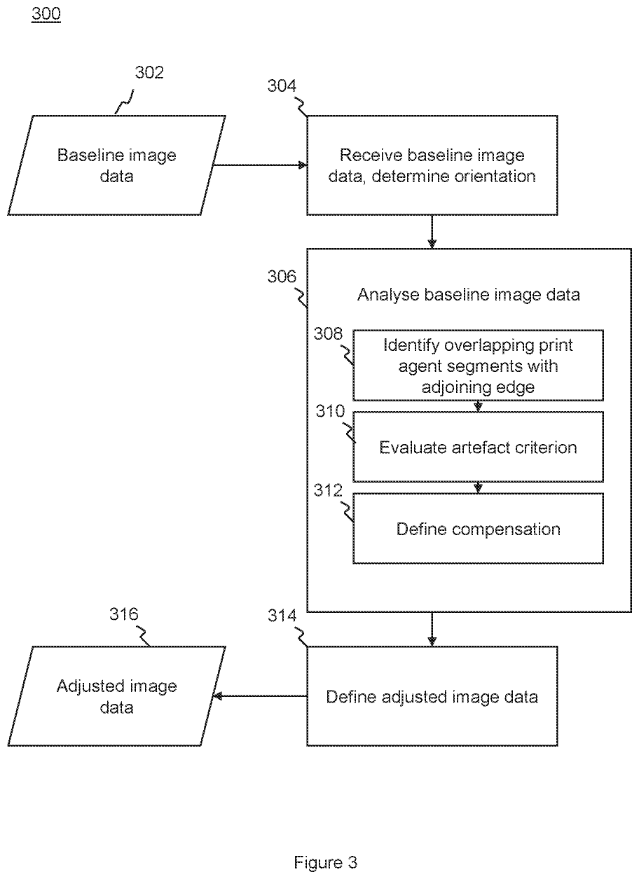

FIG. 3 is a flow diagram of an example method 300. The method 300 may be executed by a processor or controller, for example of a printing apparatus (which may perform a corresponding inkjet printing operation) or by a computing device separate from a printing apparatus.

Block 302 represents baseline digital contone image data defining an image for printing in an inkjet printing operation. For example, the image data 302 may be an image file of any type (e.g. bitmap, jpeg).

In block 304, baseline digital contone image data is received defining an image for printing in an inkjet printing operation, such as image data defining an image corresponding to the image elements of FIG. 2. An orientation of the image may be determined relative to a scanning axis corresponding to scanning of a printhead to print the image. For example, the scanning axis may be determined as one of a predetermined coordinate axis of the image (e.g. the X axis when an image has a pixel resolution expressed in as X pixels by Y pixels). Otherwise, the image data may include information defining an orientation, or a suitable orientation may be determined based on other factors (such as to ensure the printed images fits on a media size to be used in an inkjet printing operation).

In block 306, the baseline image data is analysed to compensate for an artefact relating to printing with a print agent, the analysis to be described in further detail below. The analysis is with respect to one print agent (for example a key print agent), and the image data may define an image to be printed with a plurality of print agents (for example cyan, magenta, yellow and key print agents). Where multiple print agents are to be used for an inkjet printing operation, the analysis may be performed for a subset of the print agents or all of the print agents, and may be performed individually for each of the print agents for which the analysis is to be performed.

The analysis comprises, in block 308, identifying two print agent segments (i.e. a pair) within adjacent bands of the image that overlap so that one projects along the scanning axis beyond an adjoining edge of the other by an offset. The print agent segments correspond to locations within the respective bands where the print agent is to be applied. The print agent segments may be defined in the image data, or may be derived based on the image data as described elsewhere herein. Multiple print agent segments may be evaluated in order to determine two print agent segments within adjacent bands that overlap in this manner (i.e. so that one projects along the scanning axis beyond an adjoining edge of the other by an offset), and multiple pairs of print agent segments may be determined, each pair having at least one adjoining edge.

The analysis comprises, in block 310, evaluating an artefact criterion at the adjoining edge of the pair of overlapping print agent segments. The artefact criterion may be a function of a parameter relating to the adjoining edge (e.g. a function of a plurality of such parameters), and is for determining whether a compensation for an artefact is to be applied in an edge region of the respective print agent segment which is adjacent to (terminating at) the adjoining edge. Accordingly, the artefact criterion is described herein as being evaluated “at” the adjoining edge, which may be considered equivalent to the artefact criterion being evaluated with respect to the adjoining edge. The artefact criterion being satisfied may indicate or determine that a compensation is to be applied.

The artefact criterion may have any suitable definition, such as definitions which relate to parameters which may influence the probability of a printing artefact occurring at the respective adjoining edge (in the absence of any compensation). For example, the artefact criterion may be a function of the offset by which one of the print agent segments projects beyond the respective adjoining edge. In an inkjet printing operation, this offset may correspond to a difference in temperature between sets of nozzles used to eject print agent in locations corresponding to the respective print agent segments. For example, the artefact criterion may be defined so that a compensation is determined to be applied when the offset is at or above a threshold offset, and so that a compensation is not determined to be applied when the offset is below the threshold offset.

The analysis comprises, in block 312, defining a compensation for the artefact in an edge region of the print adjacent segment having the adjoining edge, based on the evaluation of the artefact criterion. The respective edge region may be referred to herein as a compensated edge region. For example, the compensation may be defined by assigning the adjoining edge to a set of edges for which a compensation (e.g. a predetermined compensation) is to be applied when defining adjusted image data. The compensation may be defined by defining a spatial extent of compensation, for example a parameter relating to the spatial extent of the edge region in which a compensation is to be defined from the respective adjoining edge. The compensation may be defined by defining a parameter relating to an amount of compensation associated with the respective edge region, for example by a parameter defining a factor to be applied to a baseline contone level defined for pixels in the edge region in the baseline digital contone image data.

In block 314, adjusted digital contone image data 316 is defined for the image, based on the compensation. Relative to the baseline digital contone image data, the adjusted digital contone image data implements the (or any) compensation defined in block 312 to compensate for an artefact in the edge region. For example, contone levels defined for image pixels corresponding to the (or any) compensated edge region may be adjusted relative to the respective contone levels in the baseline digital contone image data. Accordingly, a printed image printed based on the adjusted digital contone image data may better approximate the image defined by the baseline digital image.

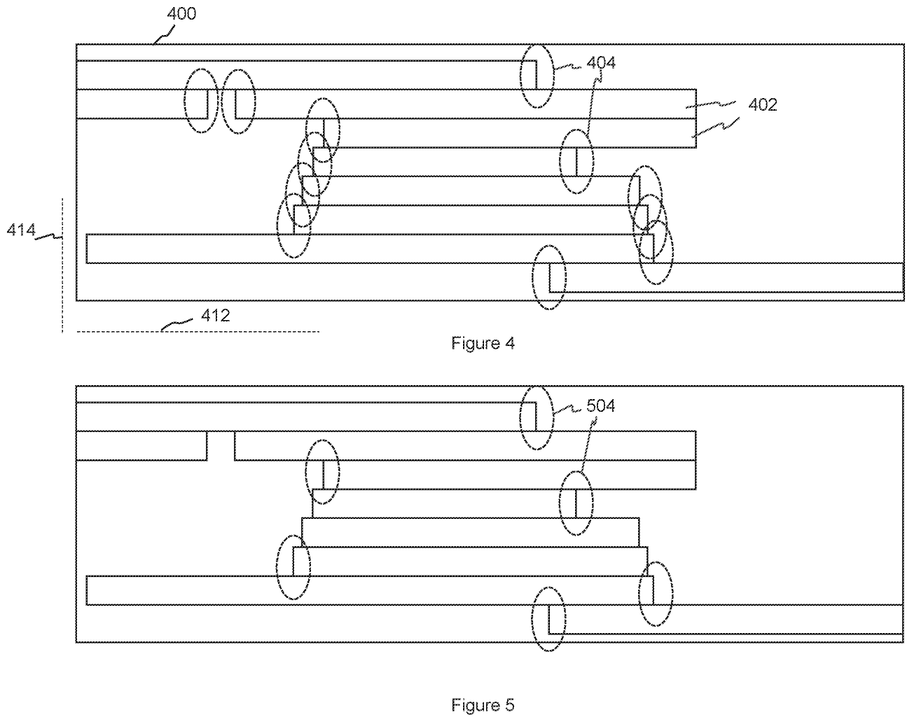

FIGS. 4-7 are a sequence of simplified schematics showing example image elements corresponding to analysis of an example image, which may be defined by image data. As described above in relation to FIG. 2, the image elements correspond to an image, such that they may be derivable from image data, but not defined in image data.

FIG. 4 shows image elements including an image space 400 and a plurality of print agent segments 402 which are elongate along a scanning axis 412, the print agent segments corresponding to a common print agent. Each of the print agent segments lie within a respective band of the image, each band extending along the scanning axis 412 and having a depth along a feed axis 414 perpendicular to the scanning axis.

In this example, the bands (and thereby the print agent segments 402) are shown as having an equal depth along the feed axis 414, for example a depth equivalent to 10 image pixels. In this example, this is owing to the form of the image itself, in which a print agent region corresponding to the locations where the print agent is to be applied takes the form of a plurality of adjoining and overlapping elongate portions of equal depth, each extending along the scanning axis.

Bands of the image may be determined, for example, by analysing the image to determine band boundaries along the feed axis which subdivide the or each print agent region into portions having edges that do not extend along the scanning axis (i.e. edges having a constant location along the scanning axis). In the example of FIG. 4, the print agent region is blocky, taking the form of adjoining and overlapping portions of equal depth, and therefore such an analysis to determine bands of the image for processing may result in bands of equal depth being determined. However, in other examples, images may be more irregular. For examples, for images with highly curvilinear forms, bands may be relatively shallow rather than deep, such as one or one or two image pixels deep. Print agent segments may be determined for analysis at unions between a print agent region and the respective band.

In this example, the print agent segments 402 are arranged so that there is a plurality of pairs of overlapping print agent segments, each pair comprising overlapping print agent segments within adjacent bands of the image, with one of the print agent segments extending beyond an adjoining edge of the other by an offset towards a respective lateral side of the image. FIG. 4 highlights (using dashed ovals) a plurality of adjoining edges 404, each belonging to a respective pair as defined above. As shown in FIG. 4, the adjoining edges can be towards either lateral side of the image, and there may be multiple print agent segments within a single band, each of which may have an adjoining edge. As shown in FIG. 4, the right-hand edges of two adjacent print agent segments are at the same position along the scanning axis, and so no adjoining edge is determined from among those edges.

As described above, an artefact criterion may be evaluated at adjoining edges of such pairs, to determine whether to define a compensation for a printing artefact in a corresponding edge region. FIG. 5 shows the image elements of FIG. 4, with the highlighting (using dashed ovals) corresponding to a subset of the adjoining edges highlighted in FIG. 4, to now highlight adjoining edges 504 for which a compensation is defined based on respective evaluations of an artefact criterion at those edges.

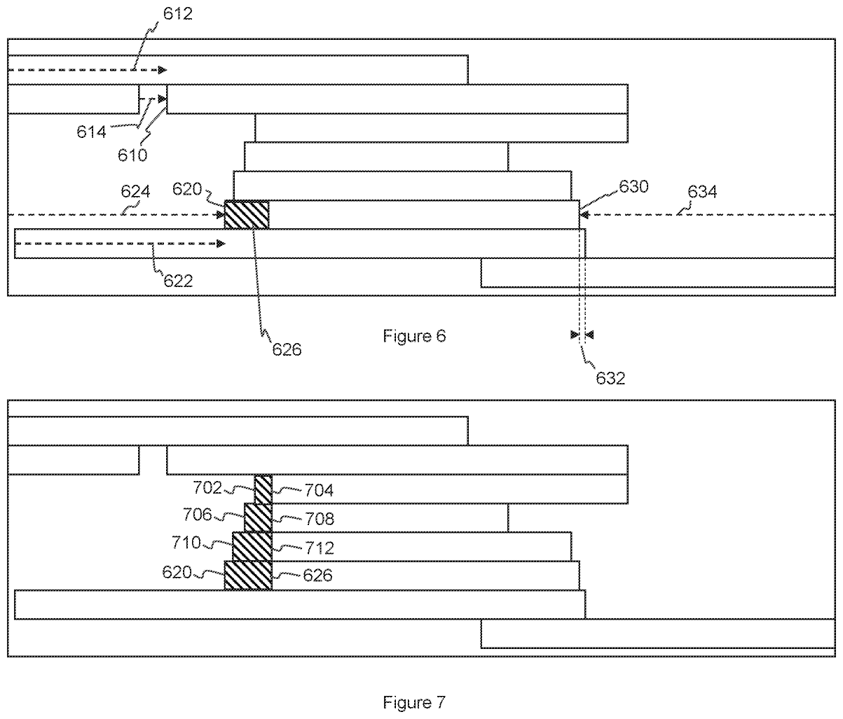

FIG. 6 shows three examples of the adjoining edges highlighted in FIG. 5 with further detail concerning associated parameters that may be used in the evaluation of an artefact criterion. The frame of reference of the image space as shown in FIG. 6 (i.e. upper, lower, left, right) is used to define the locations of the three example adjoining edges.

A first example adjoining edge 610 is the left-most edge of a second print agent segment (i.e. second from left) within the second band of the image from the top. It is an adjoining edge by virtue of being adjacent to a print agent segment within the uppermost band of the image, which extends beyond it towards the left lateral side of the image by an offset 612. The uppermost band of the image may therefore be considered to be a projecting segment of the pair, since it is the one which projects beyond the adjoining edge towards the respective lateral side of the image. The print agent segment having the adjoining edge 610 may therefore be considered to be an indented segment of the pair, since it is indented relative to the projecting segment with respect to the respective lateral side of the image. Considering that the adjoining edge is a left-most edge of the indented segment, a printing artefact may occur at a location corresponding to the adjoining edge when a printhead is scanning along the left-to-right direction so as to commence printing at the respective adjoining edge. In this example, printhead nozzles for printing at a location corresponding to the indented segment would have been inactive, prior to commencing printing at the adjoining edge 610, over an idle distance 614 along the scanning axis between the first print agent segment within the band and the adjoining edge. In other examples, there may be no such neighbouring print agent segment closer to the respective lateral side than the adjoining edge (i.e. the side towards which the projecting segment, which is the side from which the printhead would travel if a printing artefact were to occur at the respective adjoining edge). In such circumstances, the idle distance corresponds to the distance from the respective lateral side of the image. Accordingly, the idle distance may be generally defined as the distance along the scanning axis towards the respective lateral side of the image from the adjoining edge to a nearest neighbouring print agent segment in the same band or to the lateral side of the image.

In this particular example, the artefact criterion for determining to compensate for the artefact is a function of the offset by which a projecting segment extends towards the respective lateral side of the image beyond the indented segment; and a of the idle distance.

The artefact criterion may be defined so that its evaluation comprises a comparison of the offset and/or the idle distance with respective thresholds. The artefact criterion may be defined so that its evaluation comprises evaluation equations or inequalities that are functions of the offset and/or the idle distance. The artefact criterion may be defined so as to weight the relative influence of the offset and the idle distance on the outcome of the artefact criterion (i.e. whether or not a compensation is to be defined). These and other example implementations of the artefact criterion may be defined so that the artefact criterion is biased towards increasing values of the offset, and is biased towards increasing values of the idle distance. Being “biased towards” such increasing values is intended to mean that, within the state space of the possible values of the two parameters (the offset and the idle distance), there is a trend so that relatively lower values of each parameter correspond to a determination not to compensate for an artefact or to compensate for an artefact to a lesser degree, whereas relatively higher values correspond to a determination to compensate for an artefact, or to compensate for an artefact to a greater degree.

In this particular example, the artefact criterion is defined based on thresholds, so that a compensation is defined based on the artefact criterion when both the offset and the idle distance are equal to or greater than the respective thresholds, and is not defined based on the artefact criterion when one or both of the offset and the idle distance is less than its respective threshold.

With respect to the first example adjoining edge 610, in this example the offset is greater than an offset threshold for compensation, and the idle distance is less than an idle distance threshold for compensation, such that no compensation is determined.

A second example adjoining edge 620 is the left-most edge of the print agent segment within the sixth band from the top (third from the bottom) of the image. It is an adjoining edge by virtue of being adjacent to a print agent segment within the seventh band from the top (second from the bottom) of the image, which extends beyond it towards the left lateral side of the image by an offset 622. There is no neighbouring segment within the band of the adjoining edge 620 towards the respective (left) lateral side of the image, and so the idle distance 624 is the distance from the adjoining edge 620 to the respective lateral side of the image. With respect to the second example adjoining edge 610, the offset 622 is greater than the offset threshold, and the idle distance 624 is greater than the idle distance threshold, such that it is determined to compensate for a printing artefact in the edge region 626 of the print agent segment having the adjoining edge.

A third example adjoining edge 630 is the right-most edge of the print agent segment within the sixth band from the top (third from the bottom) of the image. It is an adjoining edge by virtue of being adjacent to a print agent segment within the seventh band from the top (second from the bottom) of the image, which extends beyond it towards the right lateral side of the image by an offset 632. There is no neighbouring segment within the band of the adjoining edge 630 towards the respective (right) lateral side of the image, and so the idle distance 634 is the distance from the adjoining edge 30 to the respective lateral side of the image. With respect to the third example adjoining edge 630, the offset 632 is less than the offset threshold, and the idle distance 634 is greater than the idle distance threshold, such that it is determined not to compensate for a printing artefact in an edge region corresponding to the adjoining edge.

In other examples, the artefact criterion may be defined to evaluate a scalar quantity that is a function of multiple parameters. For example, the artefact criterion may be defined to evaluate a quantity which is the sum of the offset multiplied by a first constant and the idle distance multiplied by a second constant. The quantity may then be compared with a respective threshold to determine whether to compensate for an artefact. An amount of the compensation or a spatial extent of the compensation may be variable and may be determined based on the quantity.

In other examples, the artefact criterion may be a function of the offset (e.g. alone) or the idle distance (e.g. alone), or any other suitable parameter relating to a potential printing artefact at the adjoining edge.

Evaluation of the artefact criterion may define a property of a compensation to be applied, for example by defining an amount of compensation, or a spatial extent of compensation. An amount of compensation may correspond to the amount by which a contone level is to be adjusted relative to baseline contone digital image data, for example an amount of compensation may be specified as a factor to be applied to a baseline contone level. A spatial extent of composition may correspond to the extent of a compensated edge region along the spanning axis from the respective adjoining edge. In an example implementation, the compensation is defined based on two parameters including: the extent of the compensated edge region along the spanning axis; and a factor to be applied to the contone level. For example, to lighten the contone level of image data in CMYK format, the factor may be less than 1, for example 0.8. The factor may be applied uniformly through the compensated edge region, or may be graduated, for example linearly or by an exponential decaying. To darken the contone level of image data in CMYK format, the factor may be greater than 1, for example 1.25. The amount of compensation increases as the factor increasingly deviates from 1. The factor may be a function of the idle distance and/or the offset, such that the amount of compensation can be varied based on the idle distance and/or the offset. For example, the amount of compensation may increase for increasing values of the idle distance, and/or ma increase for increasing values of the offset. The extent of the compensated edge region may be a function of the idle distance and/or the offset according to the same principles. For example, the extent of the compensated edge region may increase for increasing values of the idle distance, and/or may increase for increasing values of the offset. In other examples, the amount of compensation and/or the extent of compensation may be predetermined without dependence on parameters such as the idle distance and the offset.

FIG. 7 shows the image elements of FIG. 6 with additional example compensated edge regions 704, 708, 712 that are graduated over a set of adjoining print agent segments. In this example, the left-most edges of the print agent segments in the third to sixth bands are identified as adjoining edges. When evaluating the artefact criterion at those adjoining edges, compensated edge regions 704, 626 are determined for the adjoining edges 702, 620 in the third and sixth bands, whereas compensated edge regions are not determined in the fourth and fifth bands.

The print agent segments in the fourth and fifth bands overlap print agent segments having compensated edge regions (i.e. the segments within the third and sixth bands respectively). An analysis of image data to compensate for printing artefacts may comprise evaluating an indirect artefact criterion at an edge of a print agent segment which is identified as overlapping a print agent segment having a compensated edge region. The indirect artefact criterion may be defined so that a further compensated edge region can be defined based on the presence of a compensated adjoining edge region in the adjacent band, so as to ensure visual consistency between adjacent bands. In the example of FIG. 7, an indirect artefact criterion is evaluated at the edges of the print agent segments within the fourth and fifth segments. The indirect artefact criterion is evaluated to determine whether the edge of respective print agent segment is continuous with (e.g. at the same location along the spanning axis) or within a threshold proximity of it along the spanning axis. In this example, compensations are defined in the respective edge regions 708, 712 of those print agent segments.

In this example, the indirect artefact criterion is defined so as to determine a parameter of the compensation to be applied which may be graduated over a series of compensated edge regions, for example to provide a blended compensation over the series of compensated edge regions. For example, such a graduation may be defined when one (or more) compensated edge regions are defined based on the indirect artefact criterion between two compensated edge regions that were previously defined based on the artefact criterion (i.e. not the indirect artefact criterion).

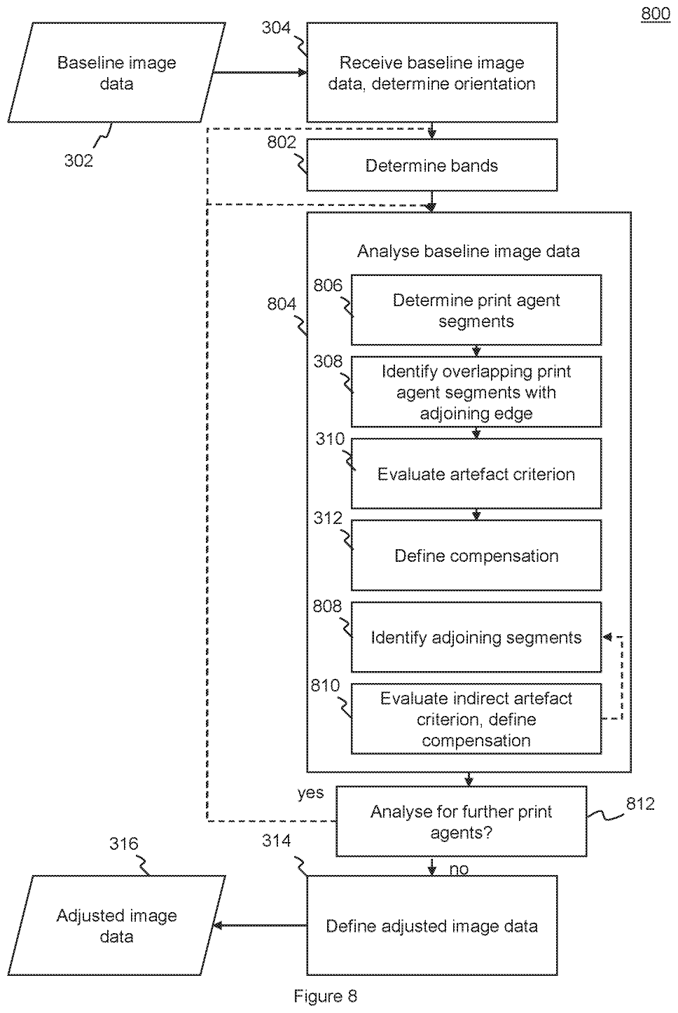

FIG. 8 is a flow diagram of a method for analysing baseline image data to compensate for a printing artefact.

Blocks 302, 304, 308, 310, 312, 314 and 316 correspond to blocks sharing the same reference numerals in the method described above with respect to FIG. 3, and so the description here is correspondingly shortened as appropriate.

Block 302 represents baseline digital contone image data defining an image for printing in an inkjet printing apparatus.

In block 304, the baseline digital contone image data is received, and an orientation of the image determined.

In block 802, bands of the image are determined for processing the baseline digital contone image data, each band extending along the scanning axis and having a depth along a feed axis perpendicular to the scanning axis. The bands may be determined as described elsewhere herein. In some examples, the determination may be of a common set of bands suitable for subsequent individual analysis of the image with respect to different print agents. In other examples, the determination may be of a set of bands suitable for analysis of the image data with respect to compensation for a first print agent, and the determination may be later repeated to determine a second set of bands suitable for analysis of the same image data with respect to compensation for a second print agent, as will be described below.

In block 804, the baseline image data is analysed to compensate for an artefact relating to printing with a print agent. The analysis is with respect to one print agent (for example a key print agent), and the image data may define an image to be printed with a plurality of print agents (for example cyan, magenta, yellow and key print agents). Where multiple print agents are to be used for an inkjet printing operation, the analysis may be performed for a subset of the print agents or all of the print agents, and may be performed individually for each of the print agents for which the analysis is to be performed.

The analysis comprises, in block 806, determining print agent segments within the respective set of bands. Print agent segments may be determined in at least two bands, by determining a print agent segment at a union between a print agent region of the image in which the print agent is to be printed and the respective band. Print agent segments may be determined at every such union with a band, or less than every such union. Print agent segments may be determined for every band with which a print agent region intersects, or a proper subset of those bands.

The analysis comprises, in block 308 identifying two print agent segments (i.e. a pair) within adjacent bands of the image that overlap so that one projects along the scanning axis beyond an adjoining edge of the other by an offset. Multiple print agent segments may be evaluated in order to determine two print agent segments within adjacent bands that overlap in this manner (i.e. so that one projects along the scanning axis beyond an adjoining edge of the other by an offset), and multiple pairs of print agent segments may be determined, each pair having at least one adjoining edge.

The analysis comprises, in block 310, evaluating an artefact criterion at the adjoining edge of the pair of overlapping print agent segments. The evaluation and the artefact criterion may be as described elsewhere herein. The artefact criterion may be evaluated at a plurality of adjoining edges associated with respective pairs of overlapping print agent segments.

The analysis comprises, in block 312, defining a compensation for the artefact in an edge region of the print adjacent segment having the adjoining edge, based on the evaluation of the artefact criterion. The compensation may be defined as described elsewhere herein. Compensations may be defined in a plurality of edge regions based on respective evaluations of the artefact criterion at a plurality of adjoining edges associated with respective pairs of print agent segments.

The analysis comprises, in block 808, identifying an adjoining print agent segment which overlaps a print agent segment having a compensated edge region for which a compensation has been defined. In block 810, the analysis comprises evaluating an indirect artefact criterion at an edge of the adjoining print agent segment, the indirect artefact criterion relating to the edge being continuous with the edge of the compensated edge region or within a threshold proximity of it along the scanning axis. The analysis comprises defining a compensation for the artefact in an edge region of the adjoining print agent segment, based on the evaluation of the indirect artefact criterion. The identification of an adjoining print agent segment, the evaluation of the indirect artefact criterion and the definition of a corresponding compensation may be as described elsewhere herein. Having defined an indirect compensation in block 810 (i.e. a compensation defined based on the indirect artefact criterion), blocks 808 and 810 may be repeated to determine if there is a further adjoining print agent segment overlapping the print agent segment in which the indirect compensation has been defined. Accordingly, a cascade of compensated edge regions may be defined by repeated evaluation of the indirect artefact criterion at respective edges. As described elsewhere herein, such compensations may be graduated over a series of adjoining edge regions to provide a blended compensation over the series.

In block 812, it is determined whether the analysis is to be conducted for further print agents. In this example, the analysis is done for each of a plurality of print agents individually, and the analysis procedure is repeated for each print agent in turn. The analysis may be repeated by re-determining bands of the image for processing based on the respective print agent channel, or may be repeated using the same bands, as indicated by the dashed lines returning to blocks 802 and 804 respectively. The plurality may be some or all of the print agents with which the image is to be printed. In other examples, the analysis may be done for multiple print agents concurrently (in this case using the same bands).

In block 314 adjusted digital contine image data 316 is defined for the image, based on the compensation or compensations determined in the preceding blocks.

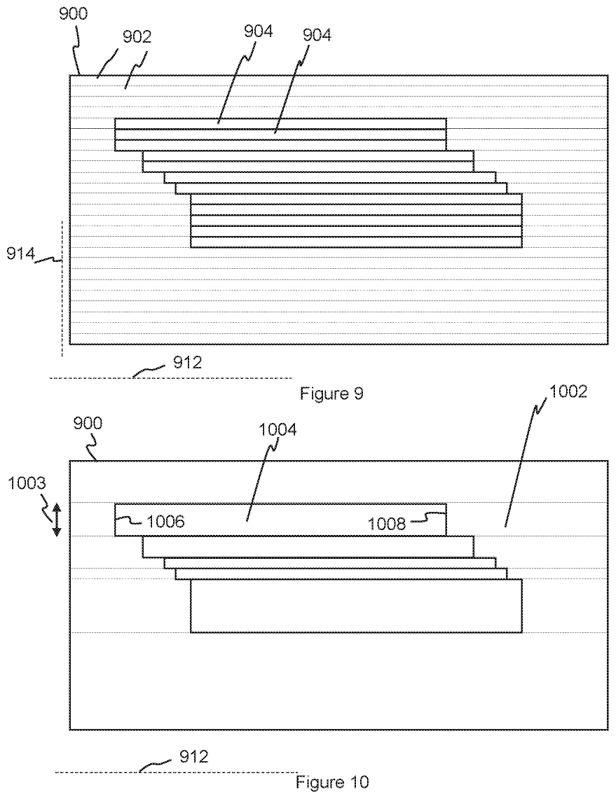

FIG. 9 is an example illustrating image elements within an image space 900 corresponding to an example image defined by baseline digital contone image data. The dashed lines indicate bands 902, which in this example are of equal depth along a feed axis 914. For example, the bands may be one image pixel deep, or more than one image pixel, such as 10 image pixels deep. By way of example, a print agent region for the image includes some portions which have continuous edges (i.e. at the same position along a scanning axis 912) across multiple bands. Nevertheless, in this example, the bands are maintained at the constant thickness, rather than expanded to correspond to the depth of the respective portion. For example, the upper three print agent segments lie within separate bands but have edges at identical locations along the scanning axis 912. A compensation may be defined in an edge region at the right-most edge of the third print agent segment, based on an artefact criterion as defined herein. A corresponding compensation may then be defined in corresponding edge regions of the second and then the first print agent segments based on an indirect artefact criterion as defined herein.

FIG. 10 is an example illustrating image elements within an image space 900 corresponding to the same example image as FIG. 9. In this example, bands 1002 are determined for processing of the image which have a variable depth 1003. For example, the bands may be determined by determining band locations which correspond to portions 1004 of a print agent region of the image which extend between opposing edges 1006, 1008 at fixed locations (i.e. edges having a constant coordinate along the scanning axis 912, or not extending along the scanning axis 912).

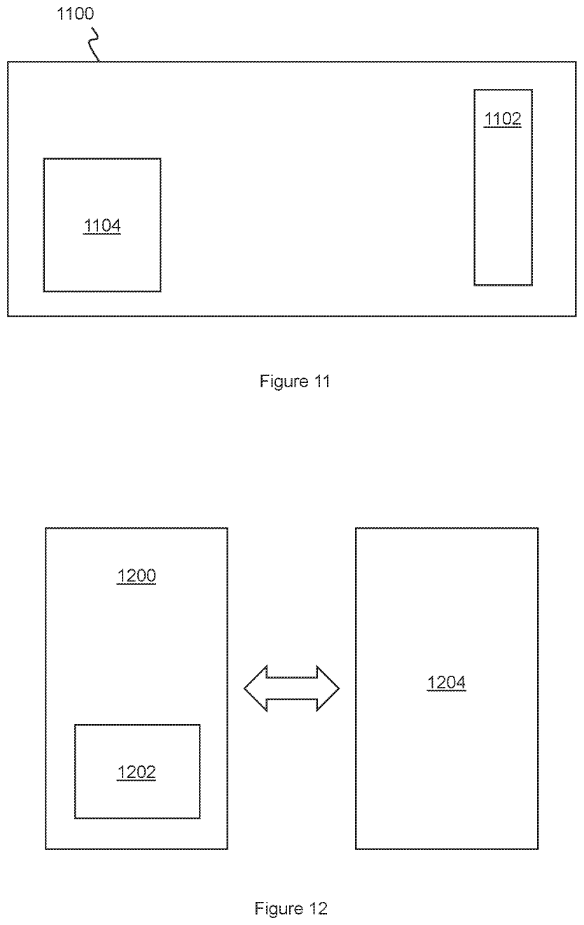

FIG. 11 shows an example inkjet printing apparatus 1100 comprising a printhead 1102 and a controller 1104. The controller may be to perform a method of analysing digital contone image data to compensate for a printing artefact as described herein, for example a method as described with reference to the flow diagrams of FIG. 3 or 8.

Examples in the present disclosure can be provided as methods, systems or machine readable instructions, such as any combination of software, hardware, firmware or the like. For example, FIG. 12 shows a machine readable storage medium 1200 comprising instructions 1202 to be executed by a processor 1204. Such machine readable instructions may be included on a machine readable storage medium (including but is not limited to disc storage, CD-ROM, optical storage, etc.) having computer readable program codes therein or thereon. The instructions may be to perform a method of analysing digital contone image data to compensate for a printing artefact as described herein, for example a method as described with reference to the flow diagrams of FIG. 3 or 8.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving baseline digital contone image data defining an image for printing in an inkjet printing operation,
determining an orientation of the image relative to a scanning axis corresponding to scanning of a printhead to print the image;
analysing the baseline image data to compensate for an artefact relating to printing with a print agent, by:
based on the baseline image data, identifying two print agent segments within adjacent bands of the image that overlap so that one projects along the scanning axis beyond an adjoining edge of the other by an offset, the print agent segments corresponding to locations within the respective bands where the print agent is to be applied;
evaluating an artefact criterion at the adjoining edge;
defining a compensation for the artefact in an edge region of the print agent segment having the adjoining edge, based on the evaluation of the artefact criterion;
defining adjusted digital contone image data for the image based on the compensation.

2. A method according to claim 1, further comprising determining a plurality of bands of the image for processing the baseline digital contone image data, each band extending along the scanning axis and having a depth along a feed axis perpendicular to the scanning axis; and
for at least two bands, determining a print agent segment at a union between a print agent region of the image in which the print agent is to be printed and the respective band.

3. A method according to claim 1, wherein the bands of the image have a depth along a feed axis perpendicular to the scanning axis, and wherein the depths of the bands are:
one image pixel deep;
of equal depth between the bands; or
of variable depth between the bands.

4. A method according to claim 1, wherein the artefact criterion is evaluated at a plurality of adjoining edges associated with respective pairs of overlapping print agent segments.

5. A method according to claim 1, wherein the artefact criterion is a function of the offset.

6. A method according to claim 1, wherein the print agent segment having the adjoining edge is an indented segment and the print agent segment extending beyond the adjoining edge is a projecting segment;
wherein the artefact criterion is a function of:
the offset by which the projecting segment extends towards a respective lateral side of the image beyond the indented segment; and
an idle distance defined as the distance along the scanning axis towards the respective lateral side of the image, from the respective edge of the indented segment to a nearest neighbouring print agent segment in the same band or the lateral side of the image;
wherein the artefact criterion for determining to compensate for the artefact is biased towards increasing values of the offset, and is biased towards increasing values of the idle distance.

7. A method according to claim 1, further comprising identifying an adjoining print agent segment which overlaps a print agent segment having a compensated edge region for which a compensation has been defined; and
evaluating an indirect artefact criterion at an edge of the adjoining print agent segment, the indirect artefact criterion relating to the edge being continuous with the edge of the compensated edge region or within a threshold proximity of it along the scanning axis;
defining a compensation for the artefact in an edge region of the adjoining print agent segment, based on the evaluation of the indirect artefact criterion.

8. A method according to claim 1, wherein the analysis of the baseline digital contone image data to compensate for the artefact is individually conducted for a plurality of print agents.

9. A method according to claim 1, wherein the adjustment relative to the baseline digital contone image to compensate for the artefact comprises increasing or decreasing the contone level associated with the respective print agent within the respective edge region to lighten the image.

10. A machine readable medium comprising instructions which, when executed by a processor, cause the processor to:
analyse baseline image data relating to an image to compensate for an artefact relating to printing with a print agent, the image having opposing lateral sides spaced apart along a scanning axis, wherein the instructions to conduct the analysis comprise instructions:
to identify a plurality of print agent segments within bands of the image, the print agent segments corresponding to locations within the respective bands where the print agent is to be applied;
to evaluate an artefact criterion at an edge of a print agent segment to determine whether to compensate for the artefact in a respective edge region of the print agent segment;
wherein the artefact criterion is a function of an offset along the scanning axis by which an overlapping print agent segment within an adjacent band projects beyond the edge towards a respective lateral side of the image.

11. A machine readable medium according to claim 10, wherein the instructions are to evaluate the artefact criterion based on:
the offset by which the overlapping print agent segment extends towards a respective lateral side of the image beyond the respective edge of the print agent segment; and
an idle distance defined as the distance along the scanning axis towards the respective lateral side of the image, from the respective edge of the print agent segment to a nearest neighbouring print agent segment in the same band, or to the lateral side of the image;
wherein the artefact criterion for determining to compensate is biased towards increasing values of the offset, and is biased towards increasing values of the idle distance.

12. A machine readable medium according to claim 10, wherein the instructions are to individually perform the analysis of the baseline image data for a plurality of print agents.

13. An inkjet printing apparatus comprising:
a controller to receive baseline digital contone image data defining an image for printing and to analyse the image data to compensate for an artefact relating to printing with a print agent;
wherein, to perform the analysis, the controller is:
to identify edges of print agent segments within bands of the image, the print agent segments corresponding to locations within the respective bands where the print agent is to be applied;
to analyse the positions of the edges of a pair of overlapping print agent segments along a scanning axis of the image to determine when one print agent segment of a respective pair projects along the scanning axis beyond an adjoining edge of the other print agent segment of the pair by an offset;
to evaluate an artefact criterion at the adjoining edge to determine whether to define a compensation for the artefact in a respective edge region of the print agent segment;
wherein the controller is to define adjusted digital contone image data for the image to implement the compensation.

14. An inkjet printing apparatus according to claim 13, wherein the controller evaluates the artefact criterion based on:
the offset by which the projecting segment of a respective pair extends beyond the respective adjoining edge of other print agent segment of the pair; and
an idle distance defined as the distance along the scanning axis towards a respective lateral side of the image, from the adjoining edge to a nearest neighbouring print agent segment in the same band or to the lateral side of the image;
wherein the artefact criterion for determining to compensate is biased towards increasing values of the offset, and is biased towards increasing values of the idle distance.

15. An inkjet printing apparatus according to claim 13, wherein the controller is to individually analyse the image data for a plurality of print agents for printing the image.
